(19) United States
(12) Patent Application Publication
(10) Pub. No.: US 2025/0105563 A1
(43) Pub. Date: Mar. 27, 2025

(54) CONNECTOR BRACKET AND WIRING HARNESS

(71) Applicant: SUMITOMO WIRING SYSTEMS, LTD., Mie (JP)

(72) Inventor: Ryo SASAKI, Mie (JP)

(21) Appl. No.: 18/729,883

(22) PCT Filed: Jan. 6, 2023
(86) PCT No.: PCT/JP2023/000216

§ 371 Date: Jul. 17, 2024

(30) Foreign Application Priority Data
Jan. 25, 2022 (JP) 2022-009271

(51) Int. Cl. H01R 13/73

(52) U.S. Cl. CPC H01R 13/73

(57) ABSTRACT

A connector bracket (14) includes a strip-like connector holding portion (34), an engaging portion (35) and a restricting portion (47). The connector holding portion (34) holds a first connector (10) on a bracket body (16) by surrounding the first connector (10). The engaging portion (35) is engaged with a tip of a connector holding portion (34) closed to hold the first connector (10). The restricting portion (47) restricts a movement of the connector holding portion (34) in a second direction (K2) intersecting a first direction (K1) if an engaging direction of the connector holding portion (34) with the engaging portion (35) is the first direction (K1).

### TECHNICAL FIELD

The present disclosure relates to a connector bracket and a wiring harness.

### BACKGROUND

Conventionally, a structure for locking a connector in a holder provided in an electrical connection box is known as disclosed in Patent Document 1. Patent Document 1 relates to a technique for mounting a connector in a holder by engaging a rail protrusion provided on the connector with a rail recess provided in the holder.

### PRIOR ART DOCUMENT

### Patent Document

Patent Document 1: JP H08-180933 A

### SUMMARY OF THE INVENTION

### Problems to be Solved

To make it difficult for a connector to come out from a holder, a structure for further holding the connector mounted in the holder by a member such as a band is, for example, being studied. In the case of this structure, if the band comes off, this possibly causes the connector to come out. Thus, a measure for making it difficult for the band to come off has been necessary.

The present disclosure aims to provide a connector bracket and a wiring harness capable of making the disengagement of a connector holding portion from an engaging portion less likely to occur.

### Means to Solve the Problem

One aspect of the present disclosure is directed to a connector bracket for holding a connector provided on an end part of a wire on a bracket body, the connector bracket being provided with a strip-like connector holding portion for holding the connector on the bracket body by surrounding the connector, an engaging portion to be engaged with a tip of the connector holding portion closed to hold the connector, and a restricting portion for restricting a movement of the connector holding portion in a second direction intersecting a first direction if an engaging direction of the connector holding portion with the engaging portion is the first direction.

Another aspect of the present disclosure is directed to a wiring harness with a wire including a connector on an end part, and a connector bracket for holding the connector on a bracket body, the connector bracket including a strip-like connector holding portion for holding the connector on the bracket body by surrounding the connector, an engaging portion to be engaged with a tip of the connector holding portion closed to hold the connector, and a restricting portion for restricting a movement of the connector holding portion in a second direction intersecting a first direction if an engaging direction of the connector holding portion with the engaging portion is the first direction.

### Effect of the Invention

The present disclosure can make the disengagement of a connector holding portion from an engaging portion less likely to occur.

### BRIEF DESCRIPTION OF THE DRAWINGS

FIG. 1 is a perspective view showing a mounted state of a connector bracket in a vehicle.

FIG. 2 is a perspective view showing a band-like holding portion of the connector bracket.

FIG. 3 is an exploded perspective view showing a rail-like holding portion and the band-like holding portion of the connector bracket.

FIG. 4 is a back view of the connector bracket.

FIG. 5 is a perspective view of the connector bracket before being mounted on a connector when viewed from front.

FIG. 6 is a perspective view of the connector bracket before being mounted on the connector when viewed from behind.

FIG. 7 is a side view of the connector bracket.

FIG. 8 is a perspective view of a restricting portion.

FIG. 9 is a diagram showing a connector mounting procedure.

FIG. 10 is a diagram showing the connector mounting procedure.

FIG. 11 is a diagram showing the connector mounting procedure.

FIG. 12 is a diagram showing the connector mounting procedure.

### DETAILED DESCRIPTION TO EXECUTE THE INVENTION

First, embodiments of the present disclosure are listed and described.

The connector bracket of the present disclosure is configured to hold a connector provided on an end part of a wire on a bracket body and provided with a strip-like connector holding portion for holding the connector on the bracket body by surrounding the connector, an engaging portion to be engaged with a tip of the connector holding portion closed to hold the connector, and a restricting portion for restricting a movement of the connector holding portion in a second direction intersecting a first direction if an engaging direction of the connector holding portion with the engaging portion is the first direction.

According to this configuration, the tip of the connector holding portion is engaged with the engaging portion while the connector is surrounded by the connector holding portion and the connector holding portion is closed in the first direction. In this way, the connector is held on the bracket body by the connector holding portion. In this held state, even if a load in the second direction, which possibly disengages the connector holding portion from the engaging portion, is applied to the connector holding portion, the movement of the connector holding portion in the second direction is restricted by the restricting portion. Thus, the disengagement of the connector holding portion from the engaging portion can be made less likely to occur.

The engaging portion includes an opening in one side surface in the second direction. The restricting portion includes a first restricting portion for restricting a movement of the connector holding portion toward one side in the second direction by being formed on an end edge of the opening to contact an outer side surface on the tip of the connector holding portion and a second restricting portion formed in the engaging portion to restrict a movement of the connector holding portion toward the other side in the second direction.

According to this configuration, the movement of the connector holding portion toward the one side in the second direction is restricted by the first restricting portion, and the movement of the connector holding portion toward the other side in the second direction is restricted by the second restricting portion. Thus, the connector holding portion can be positioned and held not to move toward the both sides in the second direction by the first and second restricting portions. Thus, it is possible to suppress the disengagement of the connector holding portion from the engaging portion due to a movement in the second direction.

The connector holding portion includes a pinch portion on a tip of a strip-like portion, the pinch portion being provided to project from the strip-like portion supporting the connector when being closed. The opening is provided not to interfere with the pinch portion when the connector holding portion is closed. The first restricting portion restricts the movement of the connector holding portion toward the one side in the second direction by contacting the outer side surface of the pinch portion. The second restricting portion is formed in the engaging portion and restricts the movement of the connector holding portion toward the other side in the second direction by contacting an inner side surface of the pinch portion.

According to this configuration, since the connector holding portion is easily held by pinching the pinch portion with fingers, workability in attaching and detaching the connector holding portion to and from the engaging portion can be improved. Further, a movement of the connector holding portion can be restricted by bringing the restricting portion into contact with the pinch portion having a large contact surface. This is more advantageous in preventing the disengagement of the connector holding portion from the engaging portion.

The restricting portion includes a third restricting portion projecting from the engaging portion to be located on a back surface of the pinch portion when the connector holding portion is engaged with the engaging portion. According to this configuration, since the disengagement of the connector holding portion from the engaging portion is also restricted by the third restricting portion, the connector holding portion can be made even less likely to be disengaged from the engaging portion.

The first restricting portion includes a protrusion capable of restricting a movement of the connector holding portion and a thinned portion having a smaller width than the protrusion. According to this configuration, the connector holding portion engaged with the engaging portion can be firmly supported by the protrusion of the first restricting portion, which is more advantageous in preventing the disengagement of the connector holding portion from the engaging portion. Further, by providing the first restricting portion with the thinned portion, a finger placement space when the connector holding portion is held can also be provided. Thus, workability in attaching and detaching the connector holding portion to and from the engaging portion can also be improved.

The restricting portion is formed to be resiliently deformable by an operation load applied from a worker in attaching and detaching the connector holding portion to and from the engaging portion. According to this configuration, the connector holding portion can be attached to and detached from the engaging portion while the restricting portion is resiliently deformed. Since the restricting portion is not too hard as just described, the restricting portion does not hinder the attachment and detachment of the connector holding portion. Thus, workability in attaching and detaching the connector holding portion can be improved.

At least one of the connector holding portion, the engaging portion and the restricting portion is integrally formed to the bracket body. According to this configuration, a structure for assembling the connector holding portion, the engaging portion and the restricting portion with the bracket body and an assembly step are not necessary.

The connector holding portion supports a part to be connected to a mating connector in the connector. According to this configuration, a part, to which a load is easily applied, in the connector is held by the connector holding portion. Thus, the connector can be made less likely to be detached from the connector bracket.

The connector bracket is provided with a rail-like holding portion for mounting and holding the connector by a rail structure. According to this configuration, since the connector is held on the bracket body not only by the connector holding portion, but also by the rail-like holding portion, the connector can be held on the bracket body at a plurality of positions. Thus, the connector can be made even less likely to be detached from the connector bracket.

The connector bracket is provided with a lock mechanism for fixing the connector to the bracket body by hooking a projection formed on one of the connector and the bracket body to the other when the connector is mounted on the rail-like holding portion along a guiding rail having the rail structure. According to this configuration, a state where the connector is held by the rail-like holding portion can be maintained by the lock mechanism. Thus, the connector can be made even less likely to be detached from the connector bracket.

The rail-like holding portion holds the connector on a first surface of the connector. The connector holding portion holds the connector on a second surface opposite to the first surface in the connector. According to this configuration, the connector can be firmly held on the bracket body by a plurality of the surfaces. Thus, the connector can be made even less likely to be detached from the connector bracket.

The rail-like holding portion and the connector holding portion are respectively arranged at positions near one end and the other end of the connector in the second direction. According to this configuration, since the connector is held on the bracket body on the both ends in an insertion/withdrawal direction of the connector, the connector can be supported in a well-balanced manner. Thus, the connector can be made even less likely to be detached from the connector bracket.

If the wire is a first wire and the connector is a first connector, a second connector connected to a second wire different from the first wire is mounted in the bracket body. According to this configuration, a plurality of the connectors can be held by one connector bracket.

The wiring harness of the present disclosure is provided with a wire including a connector on an end part, and a connector bracket for holding the connector on a bracket body, the connector bracket including a strip-like connector holding portion for holding the connector on the bracket body by surrounding the connector, an engaging portion to be engaged with a tip of the connector holding portion closed to hold the connector, and a restricting portion for restricting a movement of the connector holding portion in a second direction intersecting a first direction if an engaging direction of the connector holding portion with the engaging portion is the first direction. According to this configuration, functions and effects similar to those of the aforementioned connector bracket can be obtained.

### Details of Embodiment of Present Disclosure

A specific example of the present disclosure is described below with reference to the drawings. Note that the present invention is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different from the actual one.

### Summary of Wiring Harness 1

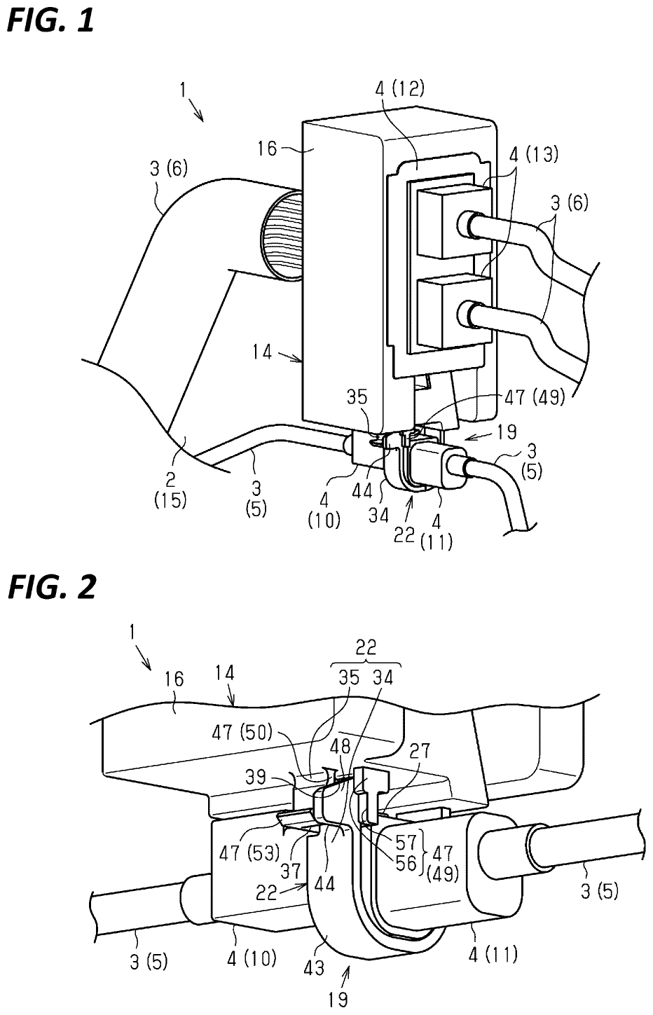

As shown in FIG. 1, an in-vehicle wiring harness 1 electrically connects electrical devices provided in a vehicle 2. The wiring harness 1 is configured by connecting a plurality of wires 3. The respective wires 3 are electrically connected by connecting connectors 4 provided on end parts. For example, the wires 3 include first wires 5 and second wires 6. The first wire 5 is, for example, an Ethernet (registered trademark) cable for connecting devices constituting an in-vehicle network LAN (Local Area Network). The second wire 6 is, for example, a wire group for electrically connecting in-vehicle devices.

Two first wires 5 are electrically connected by connecting a first connector 10, which is the connector 4 of one first wire 5, and a mating connector 11, which is the connector 4 of the other first wire 5. Two second wires 6 are electrically connected by connecting second connectors 12, which are the connectors 4 of one second wire 6, and mating connectors 13, which are the connectors 4 of the other second wire 6. Note that, in the case of an example shown in FIG. 1, the number of the mating connectors 13 of the second wire 6 is not limited to two and may be, for example, one, three or more.

The connector 4 is mounted on a vehicle body 15 via a connector bracket 14. Only one connector bracket 14 may be provided in the vehicle 2 or a plurality of connector brackets 14 may be provided. The vehicle body 15, on which the connector bracket 14 is mounted, is, for example, a vehicle body wall portion constituting a driver's seat. A known structure is appropriately used as a fixing structure for mounting the connector bracket 14 on the vehicle body 15.

The connector bracket 14 is provided with a bracket body 16 as a mounting part on the vehicle body 15. The bracket body 16 holds, for example, the second connectors 12 connected to the second wire 6. In this way, the second connector 12 is mounted and held in the bracket body 16 itself. The bracket body 16 is, for example, formed into such a shape that two side parts facing each are open, and the second connectors 12 are accommodated side by side in an opening.

### [Holding Structure of First Connector 10]

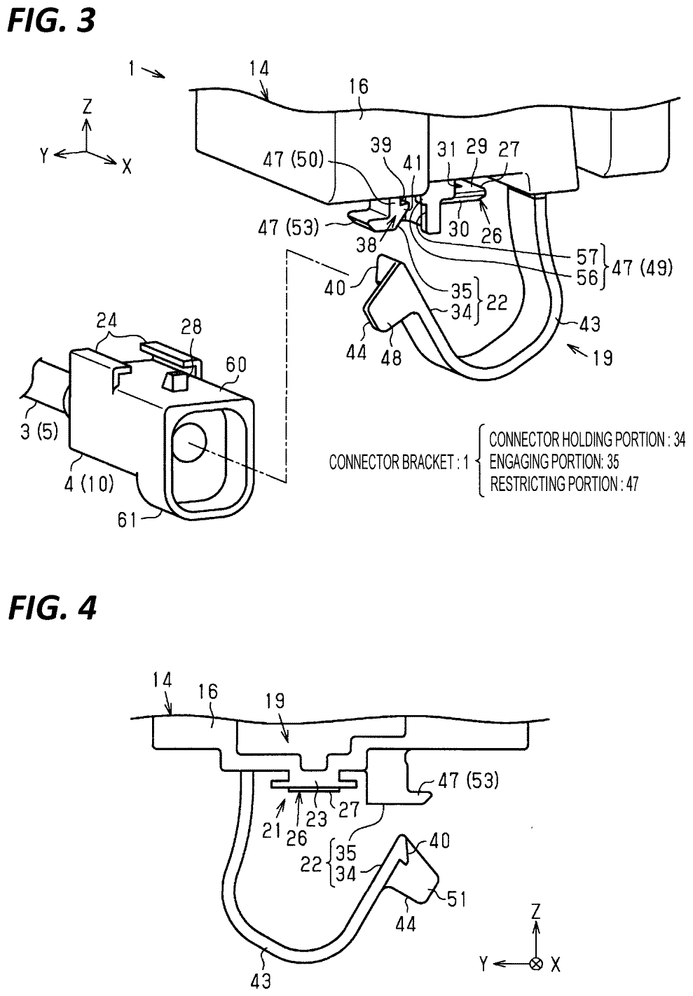

As shown in FIGS. 2 and 3, the connector bracket 14 is provided with a holder 19 for holding the first connector 10 connected to the first wire 5. The holder 19 is, for example, held on an outer surface, which can be the bottom surface of the bracket body 16. In this way, the first connector 10 is mounted and fixed to the bracket body 16 via the holder 19.

As shown in FIGS. 4 to 6, the connector bracket 14 (holder 19) is provided with a rail-like holding portion 21 for mounting and holding the first connector 10 by a rail structure and a band-like holding portion 22 for holding the first connector 10 in cooperation with the rail-like holding portion 21. The rail-like holding portion 21 holds the first connector 10 on the bracket body 16 by irregularities of the rail structure. The band-like holding portion 22 has a band structure for holding the first connector 10 on the bracket body 16 by tying a band. As just described, the connector bracket 14 holds the first connector 10 at two positions of the rail-like holding portion 21 and the band-like holding portion 22.

### [Rail-Like Holding Portion 21]

As shown in FIGS. 3 to 6, the rail-like holding portion 21 includes a guiding rail 23 (see FIG. 4 and the like) extending in a linear sliding direction (X-axis direction shown in FIG. 4 and the like) of the first connector 10. A moving rail 24 (see FIG. 3) of the first connector 10 for moving along the guiding rail 23 is fit to the guiding rail 23. The guiding rail 23 is arranged on the outer surface, which can be the bottom surface of the bracket body 16. The guiding rail 23 can be, for example, a T-shaped rail. The moving rail 24 is arranged on an outer surface, which can be the upper surface of the first connector 10.

When the first connector 10 is mounted on the rail-like holding portion 21, the moving rail 24 of the first connector 10 is fit to the guiding rail 23 of the bracket body 16 and the first connector 10 is slid in a depth direction (−X-axis direction of FIG. 3 and the like). In this way, the first connector 10 is held on the bracket body 16 by the rail-like holding portion 21. Further, when the first connector 10 is removed from the rail-like holding portion 21, the first connector 10 is slid in a direction (+X-axis direction of FIG. 3 and the like) opposite to the depth direction.

### [Lock Mechanism 26]

As shown in FIGS. 3, 5 and 6, the connector bracket 14 (holder 19) is provided with a lock mechanism 26 for fixing the first connector 10 to the bracket body 16 when the first connector 10 is mounted on the rail-like holding portion 21 along the guiding rail 23 having a rail structure. The lock mechanism 26 fixes the first connector 10 to the bracket body 16, for example, by hooking a projection 27 formed on one of the first connector 10 and the bracket body 16 to the other of these.

Specifically, the lock mechanism 26 locks a sliding movement of the first connector 10 along the guiding rail 23 by hooking the projection 27 provided on the bracket body 16 to a hooking protrusion 28 provided on the first connector 10. The projection 27 is arranged on an end part of the guiding rail 23 and formed into a shape projecting along the linear sliding direction (X-axis direction shown in FIG. 3 and the like) of the rail structure. For example, the projection 27 includes a plate-like body 29 and a claw portion 30 arranged on the tip of the body 29. The body 29 is formed with a recess 31 to be engaged with the hooking protrusion 28. The hooking protrusion 28 is arranged on the upper surface of the first connector 10.

The lock mechanism 26 is configured such that the hooking protrusion 28 of the first connector 10 enters the recess 31 of the projection 27 and the claw portion 30 is hooked to the hooking protrusion 28 when the first connector 10 is fit to the back of the guiding rail 23. By setting the lock mechanism 26 in a lock state in this way, the first connector 10 mounted on the guiding rail 23 is locked to the bracket body 16.

### [Bank-Like Holding Portion 22]

As shown in FIG. 2 and the like, the connector bracket 14 (band-like holding portion 22) includes a connector holding portion 34 and an engaging portion 35. The connector holding portion 34 is, for example, strip-like and holds the first connector 10 on the bracket body 16 by surrounding the first connector 10. As just described, the band-like holding portion 22 holds the first connector 10 on the bracket body 16 by a band structure for surrounding the first connector 10 by the strip-like connector holding portion 34. The connector holding portion 34 is integrally formed to the bracket body 16. The connector holding portion 34 supports a part of the first connector 10 to be connected to the mating connector 11, specifically, a tip part of the first connector 10.

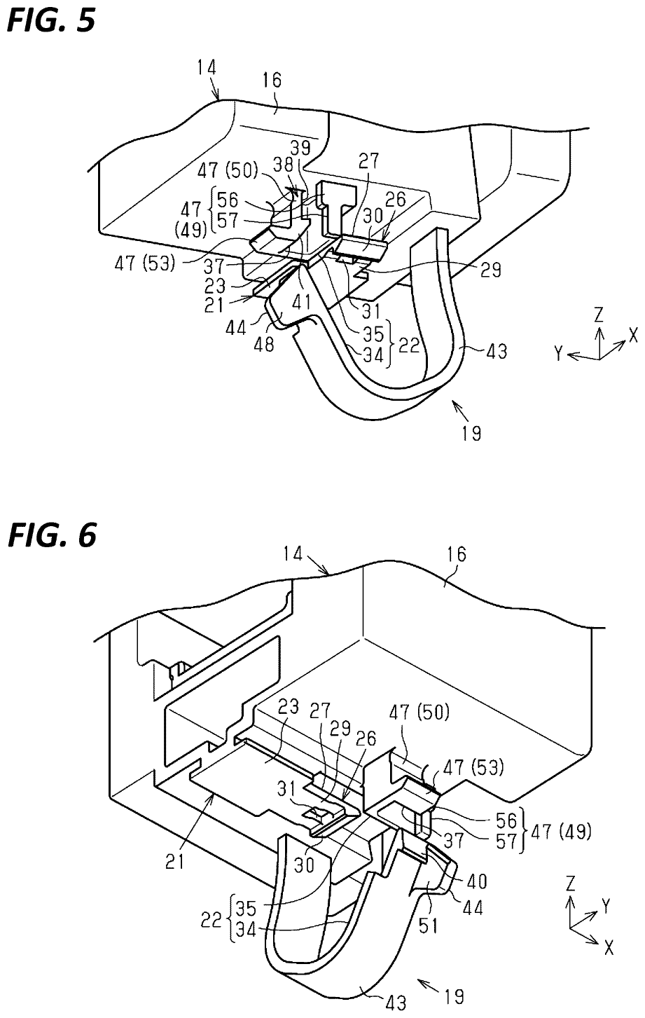

As shown in FIGS. 5 and 6 and the like, the engaging portion 35 includes an insertion hole 37, through which the tip of the connector holding portion 34 is passed, in a bottom part. The engaging portion 35 includes an opening 39 in a side surface 38 on a withdrawal side in an insertion/withdrawal direction (X-axis direction of FIG. 5 and the like) of the first connector 10 into and from the rail-like holding portion 21.

The engaging portion 35 is engaged with the tip of the connector holding portion 34 closed to hold the first connector 10. Specifically, the engaging portion 35 includes a claw fixing portion 41 engageable with a claw portion 40 (see FIG. 6 and the like) provided on the tip of the connector holding portion 34. The connector holding portion 34 is open when the claw portion 40 is not engaged with the claw fixing portion 41, and closed when the claw portion 40 is engaged with the claw fixing portion 41. The engaging portion 35 is integrally formed to the bracket body 16.

The connector holding portion 34 includes a strip-like portion 43 for supporting the first connector 10 when being closed and a pinch portion 44 provided to project from this strip-like portion 43. The pinch portion 44 is, for example, provided on the tip of the strip-like portion 43. The pinch portion 44 is a part to be held with fingers by a worker in attaching and detaching the connector holding portion 34 to and from the engaging portion 35. The pinch portion 44 is, for example, a wide projecting piece. The opening 39 is provided not to interfere with the pinch portion 44 when the connector holding portion 34 is closed.

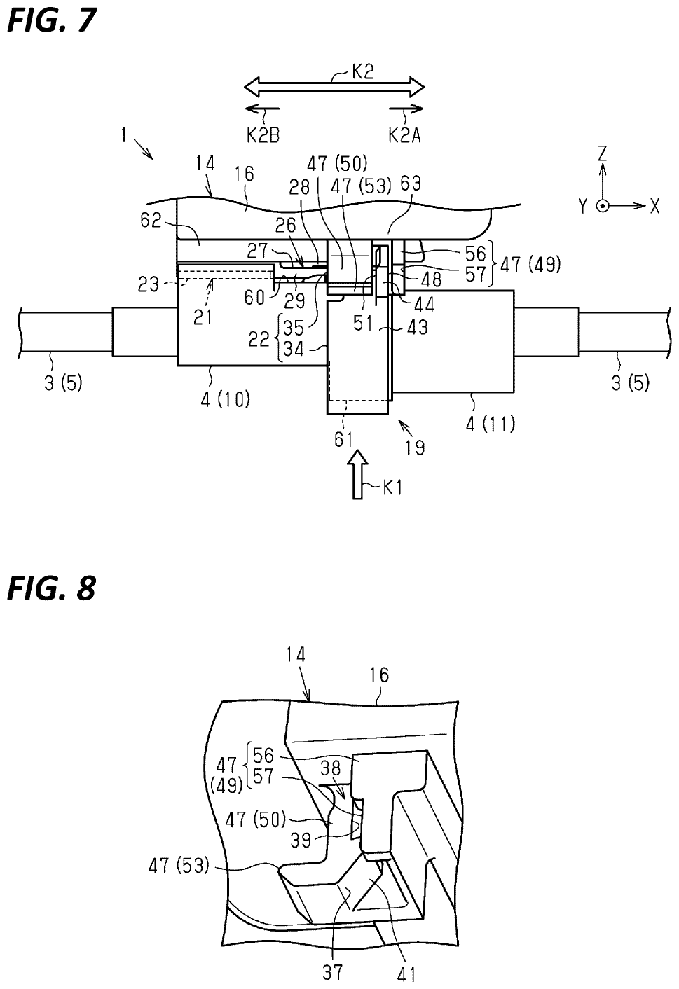

As shown in FIG. 7, an engaging direction of the connector holding portion 34 with the engaging portion 35 is an operation direction (hereinafter, referred to as a first direction K1) from below. When the connector holding portion 34 is engaged with the engaging portion 35, a movement in the vertical direction (Z-axis direction of FIG. 7) is restricted since the claw portion 40 on the tip of the connector holding portion 34 and the claw fixing portion 41 are fixed. In this way, the claw portion 40 on the tip is fixed to the claw fixing portion 41 of the engaging portion 35 while the direction from below (first direction K1) is set as a closing direction of the connector holding portion 34, wherefore the closed connector holding portion 34 hardly moves in the vertical direction.

### [Restricting Portion 47]

As shown in FIGS. 2, 7 and 8, the connector bracket 14 (holder 19) includes a restricting portion 47 for restricting a movement of the connector holding portion 34 in a second direction K2 (see FIG. 7) intersecting the first direction K1. The restricting portion 47 is formed to be resiliently deformable by an operation load applied from a worker in attaching and detaching the connector holding portion 34 to and from the engaging portion 35. The restricting portion 47 is integrally formed to the bracket body 16. The second direction K2 is, for example, a sliding direction of the first connector 10 along the guiding rail 23 of the rail-like holding portion 21.

As shown in FIG. 7 and the like, the restricting portion 47 includes a first restricting portion 49 formed on an end edge of the opening 39 to contact an outer side surface 48 of the tip of the connector holding portion 34 and a second restricting portion 50 for restricting a movement of the connector holding portion 34 in a direction opposite to the first restricting portion 49. The first restricting portion 49 restricts a movement of the connector holding portion 34 toward one side (direction of an arrow K2A of FIG. 7) in the second direction K2 by contacting the outer side surface 48 of the pinch portion 44. The second restricting portion 50 restricts a movement of the connector holding portion 34 toward the other side (direction of an arrow K2B of FIG. 7) in the second direction K2 by contacting an inner side surface 51 of the pinch portion 44.

The restricting portion 47 includes a third restricting portion 53 projecting from the engaging portion 35 to be located on the rear surface of the pinch portion 44 when the connector holding portion 34 is engaged with the engaging portion 35. The third restricting portion 53 suppresses the pinch portion 44 from being pushed in a direction to release the closed state of the connector holding portion 34. The third restricting portion 53 is a part caused to project by thickening a part of the engaging portion 35.

As shown in FIG. 8, the first restricting portion 49 includes a protrusion 56 capable of restricting a movement of the first connector 10 and a thinned portion 57 having a smaller width than the protrusion 56. The protrusion 56 is, for example, a wall projecting to close a part of the opening 39. The thinned portion 57 provides, for example, a work space when the worker attaches and detaches the connector holding portion 34 to and from the engaging portion 35. Note that the thinned portion 57 can restrict a movement of the first connector 10, for example, by an end edge projecting toward the opening 39 by a predetermined amount.

### [Arrangement Relationship of Rail-Like Holding Portion 21 and Band-Like Holding Portion 22]

As shown in FIG. 7, the rail-like holding portion 21 holds the first connector 10 on a first surface 60 of the first connector 10. The first surface 60 is, for example, the upper surface of the first connector 10. The connector holding portion 34 holds the first connector 10 on a second surface 61, which is a surface opposite to the first surface 60 in the first connector 10. The second surface 61 is, for example, the bottom surface of the first connector 10.

The rail-like holding portion 21 and the connector holding portion 34 are respectively arranged at positions near one and the other ends of the first connector 10 in the second direction K2. Specifically, the rail-like holding portion 21 and the connector holding portion 34 are respectively arranged on one end part 62 and the other end part 63 of the bracket body 16 in the insertion/withdrawal direction (X-axis direction of FIG. 7) of the first connector 10, which can be the linear sliding direction of the first connector 10. In this way, the rail-like holding portion 21 and the connector holding portion 34 are arranged on both ends separated from each other in the insertion/withdrawal direction (X-axis direction of FIG. 7) of the first connector 10.

### [Functions]

Next, functions of the connector bracket 14 (wiring harness 1) of this embodiment are described.

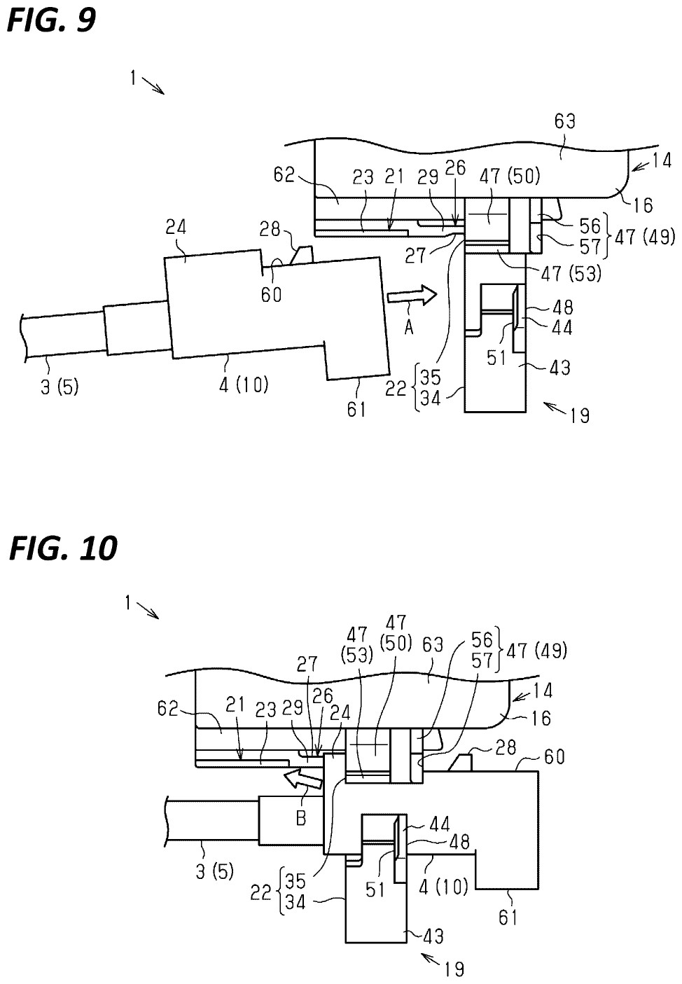

As shown in FIG. 9, the first connector 10 is first inserted into the band-like holding portion 22, in which the connector holding portion 34 is not closed, in the case of mounting the first connector 10 on the connector bracket 14. That is, the first connector 10 is inserted in a direction of an arrow A of FIG. 9 to be accommodated inside the connector holding portion 34 in the open state.

As shown in FIG. 10, after the first connector 10 is inserted into the connector holding portion 34 in the open state, the first connector 10 is mounted on the rail-like holding portion 21 of the connector bracket 14. Specifically, by pulling the first connector 10 inserted into the connector holding portion 34 in the open state in a forward direction (direction of an arrow B of FIG. 10), the moving rail 24 of the first connector 10 is fit to the guiding rail 23 of the rail-like holding portion 21.

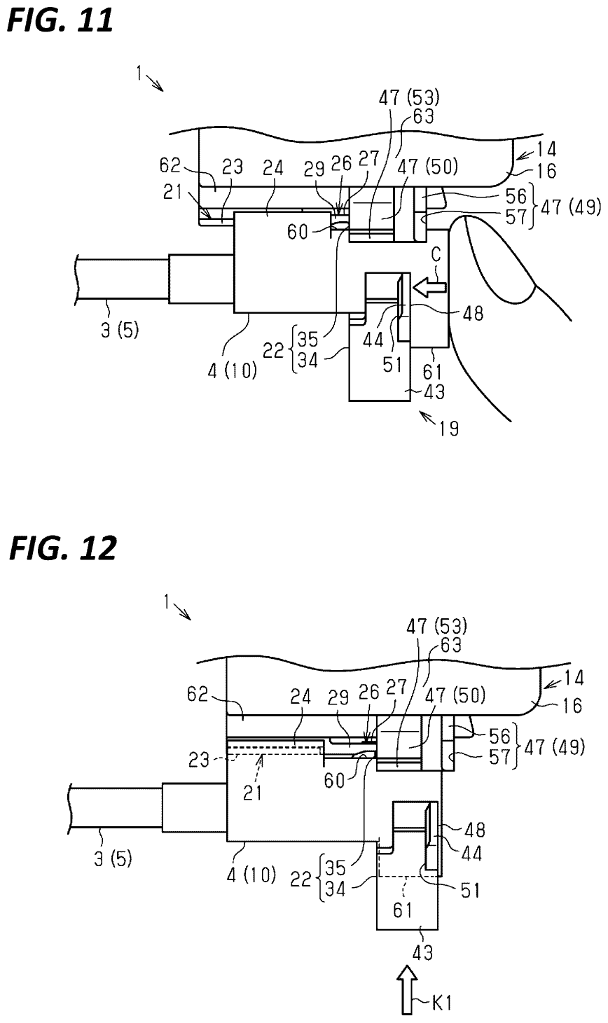

As shown in FIG. 11, the moving rail 24 of the first connector 10 is fit to the back of the guiding rail 23 of the rail-like holding portion 21 and, thereafter, further pushed in a direction of an arrow C of FIG. 11 with a finger or the like. At this time, the first connector 10 is fixed to the rail-like holding portion 21 by the lock mechanism 26. That is, if the first connector 10 is fit to the back of the guiding rail 23 of the connector bracket 14, the projection 27 of the bracket body 16 is hooked to the hooking protrusion 28 of the first connector 10 to be locked.

As shown in FIG. 12, after the first connector 10 is fit to the back of the guiding rail 23 of the rail-like holding portion 21 and locked, the first connector 10 is further held by the connector holding portion 34. For example, the claw portion 40 on the tip of the connector holding portion 34 is inserted into the insertion hole 37 of the engaging portion 35 from below (in the first direction indicated by “K1”) and, thereafter, engaged with the claw fixing portion 41 of the engaging portion 35.

The connector bracket 14 is packed with the connector holding portion 34 engaged with the engaging portion 35 and shipped to market. Thus, if a load is applied to the connector holding portion 34 in a releasing direction when the connector bracket 14 is packed or taken out from a box, there is a possibility that the connector holding portion 34 is accidentally disengaged from the engaging portion 35. If the connector holding portion 34 is disengaged from the engaging portion 35, it is also assumed that the connector holding portion 34 is unintentionally deformed. Thus, it is desired to maintain an engaged state of the connector holding portion 34 with the engaging portion 35.

For example, even if a load in the releasing direction is applied to the connector holding portion 34, the connector holding portion 34 is easily maintained in the state engaged with the engaging portion 35 since the position of the connector holding portion 34 is restricted by the restricting portion 47. Thus, it is possible to make accidental disengagement of the connector holding portion 34 from the engaging portion 35 less likely to occur.

### Effects of Embodiment

According to the connector bracket 14 (wiring harness 1) of the above embodiment, the following effects can be achieved.

(1) The connector bracket 14 holds the first connector 10 provided on the end part of the first wire 5 on the bracket body 16. The connector bracket 14 is provided with the strip-like connector holding portion 34, the engaging portion 35 and the restricting portion 47. The connector holding portion 34 holds the bracket body 16 by surrounding the first connector 10. The engaging portion 35 is engaged with the tip of the connector holding portion 34 closed to hold the first connector 10. The restricting portion 47 restricts a movement of the connector holding portion 34 in the second direction K2 intersecting the first direction K1 if the engaging direction of the connector holding portion 34 with the engaging portion 35 is the first direction K1.

According to this configuration, the tip of the connector holding portion 34 is engaged with the engaging portion 35 while the first connector 10 is surrounded by the connector holding portion 34 and the connector holding portion 34 is closed in the first direction K1. In this way, the first connector 10 is held on the bracket body 16 by the connector holding portion 34. In this held state, even if a load in the second direction K2, which possibly disengages the connector holding portion 34 from the engaging portion 35, is applied to the connector holding portion 34, a movement of the connector holding portion 34 in the second direction K2 is restricted by the restricting portion 47. Thus, the disengagement of the connector holding portion 34 from the engaging portion 35 can be made less likely to occur.

(2) The engaging portion 35 includes the opening 39 in one side surface 38 in the second direction K2. The restricting portion 47 includes the first and second restricting portions 49, 50. The first restricting portion 49 restricts a movement of the connector holding portion 34 toward the one side in the second direction K2 by being formed on the end edge of the opening 39 to contact the outer side surface 48 on the tip of the connector holding portion 34. The second restricting portion 50 is formed in the engaging portion 35 to restrict a movement of the connector holding portion 34 toward the other side in the second direction K2.

According to this configuration, the movement of the connector holding portion 34 toward the one side (direction of the arrow K2A of FIG. 7) in the second direction K2 is restricted by the first restricting portion 49, and the movement of the connector holding portion 34 toward the other side (direction of the arrow K2B of FIG. 7) in the second direction K2 is restricted by the second restricting portion 50. Thus, the connector holding portion 34 can be positioned and held not to move toward the both sides in the second direction K2 by the first and second restricting portions 49, 50. Thus, it is possible to suppress the disengagement of the connector holding portion 34 from the engaging portion 35 due to a movement in the second direction K2.

(3) The connector holding portion 34 includes the pinch portion 44, which is provided to project from the strip-like portion 43 supporting the first connector 10 when being closed, on the tip of the strip-like portion 43. The opening 39 is provided not to interfere with the pinch portion 44 when the connector holding portion 34 is closed. The first restricting portion 49 restricts the movement of the connector holding portion 34 toward the one side in the second direction K2 by contacting the outer side surface 48 of the pinch portion 44. The second restricting portion 49 restricts the movement of the connector holding portion 34 toward the other side in the second direction K2 by contacting the inner side surface 51 of the pinch portion 44.

According to this configuration, since the connector holding portion 34 is easily held by pinching the pinch portion with fingers, workability in attaching and detaching the connector holding portion to and from the engaging portion 35 can be improved. Further, a movement of the connector holding portion 34 can be restricted by bringing the restricting portion 47 into contact with the pinch portion 44 having a large contact surface. This is more advantageous in preventing the disengagement of the connector holding portion 34 from the engaging portion 35.

(4) The restricting portion 47 includes the third restricting portion 53 projecting from the engaging portion 35 to be located on the back surface of the pinch portion 44 when the connector holding portion 34 is engaged with the engaging portion 35. According to this configuration, since the disengagement of the connector holding portion 34 from the engaging portion 35 is also restricted by the third restricting portion 53, the connector holding portion 34 can be made even less likely to be disengaged from the engaging portion 35.

(5) The first restricting portion 49 includes the protrusion 56 capable of restricting a movement of the connector holding portion 34 and the thinned portion 57 having a smaller width than the protrusion 56. According to this configuration, the connector holding portion 34 engaged with the engaging portion 35 can be firmly supported by the protrusion 56 of the first restricting portion 49, which is more advantageous in preventing the disengagement of the connector holding portion 34 from the engaging portion 35. Further, by providing the first restricting portion 49 with the thinned portion 57, a finger placement space when the connector holding portion 34 is held can also be provided. Thus, workability in attaching and detaching the connector holding portion 34 to and from the engaging portion 35 can also be improved.

(6) The restricting portion 47 is formed to be resiliently deformable by an operation load applied from a worker in attaching and detaching the connector holding portion 34 to and from the engaging portion 35. According to this configuration, the connector holding portion 34 can be attached to and detached from the engaging portion 35 while the restricting portion 47 is resiliently deformed. Since the restricting portion 47 is not too hard as just described, the restricting portion 47 does not hinder the attachment and detachment of the connector holding portion 34. Thus, workability in attaching and detaching the connector holding portion 34 can be improved.

(7) At least one of the connector holding portion 34, the engaging portion 35 and the restricting portion 47 is integrally formed to the bracket body 16. According to this configuration, a structure for assembling the connector holding portion 34, the engaging portion 35 and the restricting portion 47 with the bracket body 16 and an assembly step are not necessary.

(8) The connector holding portion 34 supports the part to be connected to the mating connector 11 in the first connector 10. According to this configuration, the part, to which a load is easily applied, in the first connector 10 is held by the connector holding portion 34. Thus, the first connector 10 can be made less likely to be detached from the connector bracket 14.

(9) The connector bracket 14 is provided with the rail-like holding portion 21 for mounting and holding the first connector 10 by the rail structure. According to this configuration, since the first connector 10 is held on the bracket body 16 not only by the connector holding portion 34, but also by the rail-like holding portion 21, the first connector 10 can be held on the bracket body 16 at a plurality of positions. Thus, the first connector 10 can be made even less likely to be detached from the connector bracket 14.

(10) The connector bracket 14 is provided with the lock mechanism 36. The lock mechanism 26 fixes the first connector 10 to the bracket body 16 by hooking the projection 27 formed on one of the first connector 10 and the bracket body 16 to the other when the first connector 10 is mounted on the rail-like holding portion 21 along the guiding rail 23 having a rail structure. According to this configuration, a state where the first connector 10 is held by the rail-like holding portion 21 can be maintained by the lock mechanism 26. Thus, the first connector 10 can be made even less likely to be detached from the connector bracket 14.

(11) The rail-like holding portion 21 holds the first connector 10 on the first surface 60 of the first connector 10. The connector holding portion 34 holds the first connector 10 on the second surface 61 opposite to the first surface 60 in the first connector 10. According to this configuration, the first connector 10 can be firmly held on the bracket body 16 by the plurality of surfaces. Thus, the first connector 10 can be made even less likely to be detached from the connector bracket 14.

(12) The rail-like holding portion 21 and the connector holding portion 34 are respectively arranged at the positions near the one end and the other end of the first connector 10 in the second direction K2. According to this configuration, since the first connector 10 is held on the bracket body 16 on the both ends in the insertion/withdrawal direction of the first connector 10, the first connector 10 can be supported in a well-balanced manner. Thus, the first connector 10 can be made even less likely to be detached from the connector bracket 14.

(13) The second connector 12 connected to the second wire 6 different from the first wire 5 is mounted in the bracket body 16. According to this configuration, the plurality of connectors 4 can be held by one connector bracket 14.

### Other Embodiments of Present Disclosure

Note that this embodiment can be modified and carried out as follows. This embodiment and the following modifications can be carried out in combination without technically contradicting each other.
The restricting portion 47 may be one member having a U-shaped cross-section. In this case, the connector holding portion 34 is sandwiched and maintained in position inside the U-shaped part.
The first restricting portion 49 may be, for example, shaped to include only the protrusion 56.
The first restricting portion 49 may be shaped to cover most of the opening 39.
The second restricting portion 50 may be a wall constituting the insertion hole 37 of the engaging portion 35.
The third restricting portion 53 may be omitted.
The pinch portion 44 may be provided not on the tip of the connector holding portion 34, but on a part other than the tip.
The connector holding portion 34 may be shaped without the pinch portion 44.
The rail-like holding portion 21 may be configured such that the guiding rail 23 is provided on the first connector 10 and the moving rail 24 is provided on the connector bracket 14.
The rail structure of the rail-like holding portion 21 only has to be such that the first connector 10 can be mounted and removed along a rail part.
The band-like holding portion 22 may be arranged anywhere if the first connector 10 can be supported.
The first surface 60 on which the rail-like holding portion 21 is arranged is not limited to the upper surface of the first connector 10, but may be, for example, changed to a side part or the like of the first connector 10.
The second surface 61 on which the band-like holding portion 22 is arranged is not limited to the bottom surface of the first connector 10, but may be, for example, changed to the upper surface, a side part or the like of the first connector 10.
The rail-like holding portion 21 and the band-like holding portion 22 may be arranged on the same end part of the first connector 10.
The rail-like holding portion 21 may be omitted.
The lock mechanism may be changed to various structures if the first connector 10 fit to the guiding rail 23 can be fixed to the bracket body 16.
The part for holding the second connector 12 may be omitted from the connector bracket 14.
The wiring harness 1 may be a wire group composed of the plurality of bundled wires 3. Further, the wiring harness 1 may be a wire member covered with a coating material.
The wiring harness 1 may be used for another equipment or device without being used in the vehicle.
The base end of the connector holding portion 34 (strip-like portion 43) of the shown embodiment may be integrally formed to the bottom surface of the bracket body 16.
With the claw portion 40 provided on the tip of the connector holding portion 34 (strip-like portion 43) of the shown embodiment engaged with the claw fixing portion 41 of the engaging portion 35, the tip of the connector holding portion 34 (strip-like portion 43) may be disengaged from the engaging portion 35 and the closed state of the connector holding portion 34 may be released if a worker resiliently deforms the restricting portion 47 by moving the tip of the connector holding portion 34 (strip-like portion 43) toward the one side (direction of the arrow K2A of FIG. 7) in the second direction K2 (X-axis direction) with respect to the engaging portion 35.
As shown in FIGS. 5 to 7, the engaging portion 35 may include, for example, the first and second side walls provided on the bottom surface of the bracket body 16, facing each other in the third direction (Y-axis direction) orthogonal to the first direction K1 (Z-axis direction) and the second direction K2 (X-axis direction) and extending along the second direction K2 and the third side wall provided on the bottom surface of the bracket body 16 and coupling the end parts of the first and second side walls on the other side (direction of the arrow K2B of FIG. 7) in the second direction K2, and the insertion hole 37 may be formed in the bottom part of the engaging portion 35 by the first, second and third side walls.
As shown in FIGS. 5 and 6, the restricting portion 47 may, for example, project toward the first side wall along the third direction (Y-axis direction) from the end part of the second side wall on the one side (direction of the arrow K2A of FIG. 7) in the second direction K2 (X-axis direction) and face the end surface (side surface 38) of the first side wall on the one side in the second direction K2. For example, a distance in the second direction K2 between the restricting portion 47 and the side surface 38 may be shorter than a width of the claw portion 40 in the second direction K2.
As shown in FIGS. 5 and 6, the pinch portion 44 may, for example, project along the third direction (Y-axis direction) from the end part of the tip of the connector holding portion 34 (strip-like portion 43) on the one side (direction of the arrow K2A of FIG. 7) in the second direction K2 (X-axis direction). For example, a length along the third direction of the pinch portion 44 may be longer than a distance in the third direction between the first and second side walls. For example, a thickness in the second direction K2 (X-axis direction) of the pinch portion 44 may be shorter than a distance in the second direction K2 between the side surface 38 of the first side wall and the restricting portion 47. For example, the pinch portion 44 may be sandwiched between the side surface 38 of the first side wall and the restricting portion 47 with the claw portion 40 provided on the tip of the connector holding portion 34 (strip-like portion 43) engaged with the claw fixing portion 41 of the engaging portion 35.
Although the present disclosure has been described based on the embodiment, it is understood that the present disclosure is not limited to the embodiment and structure. The present disclosure also includes various modifications and modifications within the scope of equivalents. In addition, various combinations and forms, as well as other combinations and forms including only one element, more or less, are within the scope and spirit of the present disclosure.

### LIST OF REFERENCE NUMERALS

1 wiring harness
3 wire
4 connector
5 first wire
6 second wire
10 first connector
11 mating connector
12 second connector
13 mating connector
14 connector bracket
15 vehicle body
16 bracket body
19 holder
21 rail-like holding portion
22 band-like holding portion
23 guiding rail
24 moving rail
26 lock mechanism
27 projection
28 hooking protrusion
29 body
30 claw portion
31 recess
34 connector holding portion
35 engaging portion
37 insertion hole
38 side surface
39 opening
40 claw portion
41 claw fixing portion
43 strip-like portion
44 pinch portion
47 restricting portion
48 outer side surface
49 first restricting portion
50 second restricting portion
51 inner side surface
53 third restricting portion
56 protrusion
57 thinned portion
60 first surface
61 second surface
62 end part
63 end part
K1 first direction
K2 second direction

1. A connector bracket for holding a connector provided on an end part of a wire on a bracket body, comprising:
a strip-like connector holding portion for holding the connector on the bracket body by surrounding the connector;
an engaging portion to be engaged with a tip of the connector holding portion closed to hold the connector; and
a restricting portion for restricting a movement of the connector holding portion in a second direction intersecting a first direction if an engaging direction of the connector holding portion with the engaging portion is the first direction.

2. The connector bracket of claim 1, wherein:
the engaging portion includes an opening in one side surface in the second direction, and
the restricting portion includes a first restricting portion for restricting a movement of the connector holding portion toward one side in the second direction by being formed on an end edge of the opening to contact an outer side surface on the tip of the connector holding portion and a second restricting portion formed in the engaging portion to restrict a movement of the connector holding portion toward the other side in the second direction.

3. The connector bracket of claim 2, wherein:
the connector holding portion includes a pinch portion on a tip of a strip-like portion, the pinch portion being provided to project from the strip-like portion supporting the connector when being closed,
the opening is provided not to interfere with the pinch portion when the connector holding portion is closed,
the first restricting portion restricts the movement of the connector holding portion toward the one side in the second direction by contacting the outer side surface of the pinch portion, and
the second restricting portion is formed in the engaging portion and restricts the movement of the connector holding portion toward the other side in the second direction by contacting an inner side surface of the pinch portion.

4. The connector bracket of claim 3, wherein the restricting portion includes a third restricting portion projecting from the engaging portion to be located on a back surface of the pinch portion when the connector holding portion is engaged with the engaging portion.

5. The connector bracket of claim 2, wherein the first restricting portion includes a protrusion capable of restricting a movement of the connector holding portion and a thinned portion having a smaller width than the protrusion.

6. The connector bracket of claim 1, wherein the restricting portion is formed to be resiliently deformable by an operation load applied from a worker in attaching and detaching the connector holding portion to and from the engaging portion.

7. The connector bracket of claim 1, wherein at least one of the connector holding portion, the engaging portion and the restricting portion is integrally formed to the bracket body.

8. The connector bracket of claim 1, wherein the connector holding portion supports a part to be connected to a mating connector in the connector.

9. The connector bracket of claim 1, comprising a rail-like holding portion for mounting and holding the connector by a rail structure.

10. The connector bracket of claim 9, comprising a lock mechanism for fixing the connector to the bracket body by hooking a projection formed on one of the connector and the bracket body to the other when the connector is mounted on the rail-like holding portion along a guiding rail having the rail structure.

11. The connector bracket of claim 9, wherein:
the rail-like holding portion holds the connector on a first surface of the connector, and
the connector holding portion holds the connector on a second surface opposite to the first surface in the connector.

12. The connector bracket of claim 9, wherein the rail-like holding portion and the connector holding portion are respectively arranged at positions near one end and the other end of the connector in the second direction.

13. The connector bracket of claim 1, wherein, if the wire is a first wire and the connector is a first connector, a second connector connected to a second wire different from the first wire is mounted in the bracket body.

14. A wiring harness, comprising:
a wire including a connector on an end part; and
a connector bracket for holding the connector on a bracket body,
the connector bracket including:
a strip-like connector holding portion for holding the connector on the bracket body by surrounding the connector;
an engaging portion to be engaged with a tip of the connector holding portion closed to hold the connector; and
a restricting portion for restricting a movement of the connector holding portion in a second direction intersecting a first direction if an engaging direction of the connector holding portion with the engaging portion is the first direction.
